(19) United States
(12) Patent Application Publication
(10) Pub. No.: US 2009/0287502 A1
(43) Pub. Date: Nov. 19, 2009

(54) E-PatientLink

(75) Inventors: Michael F. Roberts, Palm Harbor, FL (US); Baxter Byerly, Brooksville, FL (US)

Correspondence Address: NEIFELD IP LAW, PC, 4813-B EISENHOWER AVENUE, ALEXANDRIA, VA, 22304, US

(73) Assignee: Catalina Marketing Corporation, St. Petersburg, FL (US)

(21) Appl. No.: 12/121,205

(22) Filed: May 15, 2008

(51) Int. Cl. G06Q 50/00

(52) U.S. Cl. 705/3

(57) ABSTRACT

A pharmacy management computer system sends de identified prescription record information to a health records computer system where Payloads including additional drug information are associated with the de identified prescription record. The Payloads are transmitted back to the pharmacy management computer system which in some cases electronically delivers them to patients. In those cases where a patient is confirmed to have received the electronic communication, the pharmacy management computer system is programmed to change its operation by printing the additional drug information in the pharmacy for delivery in the pharmacy to the patient. Subsequent communications contain content that depends upon patient response to prior communications during the pharmacy prescription process.

### FIELD OF THE INVENTION

This invention relates to pharmacy management systems.

### BACKGROUND OF THE INVENTION

United States application publication 20060266826 is titled “System to Provide Specific Messages to Patients” and discloses an apparatus and method for delivering targeted informational messages includes a computer system for creating a de-identified encrypted PID and de-identified patient transaction data in a retail store for transmission and storage. It associates a subset of de-identified encrypted PIDs with targeted informational messages, transmits them to the retail stores where the targeted message is printed on behalf of the patient corresponding to the de-identified encrypted PID.

United States application publication 20070164096 and corresponding PCT publication WO 2007/084159 are titled “PharmacyNetwork Computer System and Printer” and discloses a network computer system and novel pharmacy printers wherein the local CS includes a pharmacy printer for printing pharmacy orders including prescriptions. The pharmacy printer includes a pharmacy printer database storing drug information and association of a drug identifier with information about a corresponding drug, and additional information, and obtains and uses instructions for printing the additional information in association with printing of a prescription label from characters contained in a prescription label print file for the prescription label. Thus, the use of addresses or field identifications in a local database which addresses or field identifications are determined by running criteria on a remote computer system are disclosed.

U.S. Pat. No. 6,789,108 is titled “Method and apparatus for dissemination of rich media” and discloses a computer-implemented method for disseminating information, comprising the steps of: sending an electronic mail message to at least one recipient, said electronic mail being linked to a graphical presentation file, sensing the capabilities of the at least one recipient's computer and, supplying only the elements of the graphical presentation file which may be viewed on the at least one recipient's computer.”

The web site http://www.mirixa.com” disclose providing healthcare newsletters that become targeted either because of website visitation practices or by patient-directed data inputs.

### Acronyms and Definitions

CS is an acronym for Computer System.

POS is an acronym for Point Of Sale.

PM is an acronym for Pharmacy Management

CPM is an acronym for Central Pharmacy Management

LPM is an acronym for Local Pharmacy Management

HR is an acronym for Health Resource.

CPU is an acronym for Central Processing Unit.

ID is an acronym for IDentification.

ENC is an acronym for ENCrypted.

PID is an acronym for Patient ID.

HIPAA is an acronym for (Health Insurance Portability & Accountability Act.

PHI is an acronym for Protected Health Information.

DI is an acronym for de identified.

Pres ID stands for prescription identification.

Pres ID herein means an identification assigned to a prescription order, or an identification assigned to a de identified prescription order, and encrypted and de identified versions of such an identification assigned to a prescription order. Thus, ENC Pres ID and a DI

Pres ID are Pres IDs.

PHI are a defined set of data element that need to be either removed, encrypted or otherwise de-identified.

HIPAA regulations define data elements in PHI. A prescription ID is generally considered PHI non-compliant, even though there is no requirement that a prescription ID specification contain information traceable back to the patient name or patient contact information.

A computer system, CS, means a system of one or more computers and associated software with common data storage. A computer is a machine for performing calculations automatically.

A computer network is any set of computers or devices connected to each other with the ability to exchange data.

De-identified information, means information from which information that could be used to identify the corresponding person has been removed. That removed information includes for example, name, residence address, telephone number, email address, and demographic information particular to a small group of individuals

### SUMMARY OF THE INVENTION

A PM CS obtains an electronic address, such as an email address, for a patient, an order for a prescription for the patient, and authorization from the patient to send the patient electronic communication to the electronic address.

The PM CS transmits de identified prescription data for the prescription to a HR CS in association with an encrypted or otherwise de identified patient identifier.

The HR CS determines Payloads for association with the encrypted or otherwise de identified patient identifier. The HR CS determines Payloads by applying targeting criteria to previously received de-identified prescription orders, or previously received and the currently received de identified prescription orders, or only the currently received de identified prescription order, for those de identified prescription orders associated with the same encrypted or otherwise de identified patient identifier.

The HR CS transmits the resulting Payload in association with the encrypted or otherwise de identified version of a patient identifier back to the originating PM CS.

The PM CS automatically associates the portion of the Payload which is either information or local addresses for information, for presentation to the patient, with the electronic address provided by the patient.

The PM CS either transmits the Payload to the electronic address for the patient, or forwards the Payload and associated electronic address to an Email CS that then emails the Payload to the associated electronic address for the patient.

Sending of, or the confirmation to the PM CS of the receipt of, the electronic communication, changes how the PM CS reacts to an order to fill or refill a prescription, specifically effecting the PM CS not printing certain additional drug information such as the information required by HIPAA to be provided to the patient obtaining the filled prescription.

The Payloads include information for presentation to the patient, or addresses or field identifications of stored locally of information for presentation to the patient.

If historical de identified prescriptions data are used, then, each de-identified data for each prescription is stored in the HR CS in association with an encrypted or de identified patient identifier.

Preferably, the PM CS is programmed to receive from the patient via the patient's transmission from the patient's client CS of email or via the patient's interaction on the patient's client CS with a web site requests for filling prescriptions or for refills to existing prescriptions.

Preferably, the Payloads sent to the patient contains additional drug information about the prescribed drug. The Payloads sent to the patients may also contain marketing information and coupon offers. The Payload generated by the HR CS may also optionally include instructions to the PM CS and may also include instructions to pharmacy personnel involved in filling the specified prescription.

Optionally, email sent to the patient contains control code resulting in confirmation that the Payload was displayed on the recipient CS, such as code instructing the recipient CS to acknowledge receipt and opening of the email, or a hyperlink containing such code resulting in such acknowledgment being transmitted from the recipient computer upon activation of the hyperlinked.

Optionally, sending of, or the confirmation to the PM CS of the receipt of, the electronic communication by the patient, via a transmission from the patient's client CS also affects: instructions provided by the PM CS to a pharmacist or worker to prepare a prescription; printing of a prescription label; what data elements to include in the printing in association with the prescription or prescription label. HIPAA compliance information includes additional drug information. The data elements on the prescription label may include an indication whether the HIPAA compliance information was previously emailed to the patient, and/or printed and physically attached to the prescription received by the patient.

Two way communication between the PM CS and the HR CS without violating privacy requirements enables an application service provider model for efficiently providing additional drug information to patients, and for efficiently generating data for printing prescription labels. The ability to securely communicate the additional drug information to the patient electronically via email in some cases moots printing additional drug information.

Electronic communication to and from the patient may be by email, instant messaging, interactions with web sites, or similar network communication protocols.

As part of HIPAA compliance PM CSs generally employ fire walls (in hardware or software or both) and software code and owners thereof implement personnel policies to limit transmission of PHI information out of the PM CS.

### BRIEF DESCRIPTION OF THE FIGURES

FIG. 1 is a schematic of computer network system 100;

FIG. 2 is a schematic of HR database 30A of FIG. 1;

FIG. 3 is a schematic of one embodiment of PM1 CS 20 of FIG. 1;

FIG. 4 is a schematic of LPM1 CS 330;

FIG. 5A, FIG. 5B, and 5C are schematics in design view of portions of database 330;

FIG. 5A is a schematic in design view of a portion of Database 330A, showing Patient Record Table 510, PID Table 515, Pres ID Table 516, and Patient Prescription Table 520;

FIG. 5B is a schematic in design view of a portion of Database 330A, showing Prescription Action Table 530;

FIG. 5C is a schematic in design view of a portion of Database 330A, showing Payload Table 540;

FIG. 6 is a schematic showing tables in Email CS 20's Database 20′;

FIG. 7 shows a corresponding alternative De Identified Payload Table 230′ and part of alternative Targeting Criteria table 210′ for customized targeted messaging; and

FIG. 8 shows alternative Patient Prescription Table 520′.

### DETAILED DESCRIPTION OF EMBODIMENTS

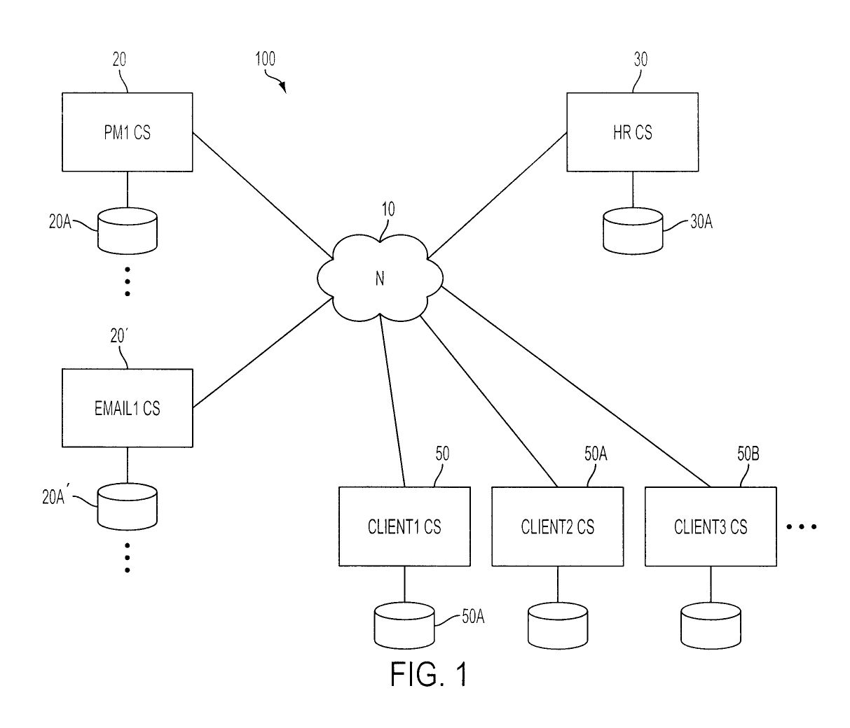

FIG. 1 is a schematic of computer network system 100. FIG. 1 shows PM1 CS 20, PM1 database 20A, HR CS 30, HR database 30A, Email CS 20′, Email database 20A′, Client1 CS 50, Client1 database 50A, and client computer systems, Client2, Client3, etc. Lines in FIG. 1 connecting enumerated components indicate data communication lines, either wired, wireless, or a combination thereof. Three ellipses in FIG. 1 and other figures indicate possible additional components of the associated type, such as additional PM CSs, Email CSs, and Client CSs.

Each CS includes a database storing data associated with that CS. Each CS may include a plurality of networked computers in a computer network. Each computer includes at least one CPU, memory such as disk or random access memory, or preferably both, and operating system software enabling the computer to execute other computer software.

Preferably, there are a plurality of PM CSs, such as PM1 CS, PM2 CS, PM3 CS (not shown), etc. Optionally, there is a corresponding Email CS associated with each PM CS, such as Email1 CS associated with PM1 CS, Email2 CS associated with PM2 CS (not shown), Email3 CS (not shown) associated with PM3 CS (not shown), etc. The association is that the Email CSs send emails and Payloads to email addresses specified by the corresponding PM CSs. Email CSs are optional since the PM CSs may be configured to perform the emailing or equivalent function of electronically communicating with the patient electronic address.

As explained below, Payloads are associated with prescriptions by HR CS 30, at least some of the Payload is content for emails to be sent to the corresponding patient in a fashion that preserves patient privacy and anonymity.

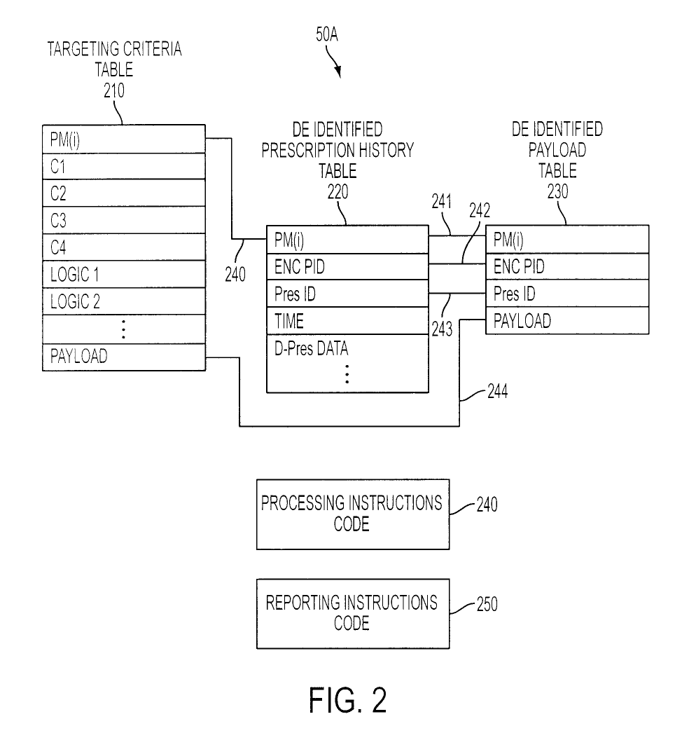

FIG. 2 is a schematic of HR database 30A of the HR CS 30. FIG. 2 shows database 30A including Targeting Criteria Table 210; De-identified Prescription History Table 220; De-identified Payload Table 230; Processing Instructions Code 240; and Reporting Instructions Code 250. The tables are shown in design view. Lines 240, 241, 242, 243, and 244 show relational links between fields in different tables that contain the same type of data. These are database links of the types well known in the art, and are well defined for use by Structure Query Language (SQL) in relational database queries. Each table stores records in the enumerated fields. Fields in one record are associated with one another. However, the database structure may employ flat files or any database management program to represent the relationships shown in tables 210, 220, and 230, in a manner well known in the art.

In Targeting Criteria Table 210, field PM(i) represents and identifier for PMs with i being a variable running from 1 to N, where N is the number of PM CSs. PM1 corresponds to the identification for PM ICS 20.

Fields C1, C2, C3, C4, . . . represent fields for various criteria applicable to data in fields in De-identified Prescription History Table 220. Logic1, Logic2, etc., represent logical combinations of criteria C1, C2, C3, C4, . . . , such as logical And, Or, Not, And Not, Or Not specifying one or more of the Ci criteria. The Payload field contains data specifying information for transmission to a Client CS whose De-identified prescription history in records in table 220 meets the criteria specified in the corresponding record in table 210, and optionally additional information providing instructions to the PM CS.

In De-identified Prescription History Table 220, encrypted patient identification field ENC PID stores in an encrypted version of a patient identification PID. The corresponding unencrypted version of the PID is stored by PM ICS 20 in database 20A. Table 220 is shows optional field Pres ID for storing a prescription ID. However, this field may store an encrypted or de identified version of the Pres ID stored in the PM CS for the same prescription, in order to maintain PHI. PM1 CS 20 optionally sends to HR CS 30 an encrypted or de identified version of that Pres ID.

In De-identified Prescription History Table 220, PM(i) stores identification of a corresponding PM CS in which the PID and Pres ID are stored for the same prescription. Each record in Table 220 also stores in field, Time, a time associated with a prescription order, such as a time when the order was received by the PM CS or the HR CS. In implementations in which HR CS 30 does not use historical data in determining Payloads, PM1 CS 20 may transmit either the ENC PID or an encrypted or de identified version of that Pres ID to HR CS 30. HR CS 30 would there after transmit back the same identification it received along with a Payload.

In one embodiment, HR CS 30 receives no Pres ID from PM1 CS 20, and HR CS 30 generates its own Pres ID and transmits that back to PM1 CS 20 for tracking of refills of that prescription, and for tracking of later in time subsequent Payloads associated by HR CS 30 with that same prescription.

In De-identified Prescription History Table 220, D-PresData and the ellipses below it represent plural data fields for de-identified prescription data. Each record in Table 220 also stores in fields (plural fields), D-PresData, de-identified prescription data for a prescription. The fields D-PresData in Table 220 are the same or similar to the de-identified data fields for prescriptions contained in Table 520 in the PM1 CS 20's database 20A.

De-identified Payload Table 230 contains the data necessary to uniquely associate a Payload with a PID and optionally with a prescription ID in the PM1 CS 20. De-identified Payload Table 230 including fields for PM(i), ENC PID, optionally a Pres ID, and a Payload.

One example of information in a record in Targeting Criteria Table 210 record is:

### CMP(i)=PM1;

C1=drug1 within the last year;
C2=drug2 this order;
C3=drug3 ever;
C4=drug5 ever;

### Logic1=C1 and C2 and C3;

### Logic2=C1 and Not C4;

Payload=drug2 HIPAA required information, and information about for drug4.

One example of information in a record in De-identified Prescription History Table 220 is the following fields and exemplary data values:

### PM(i)=PM1;

Pharmacy ID=47 (which also identifies a LPM CS for that pharmacy)

### ENC PID=1467339

### Pres ID=100475

### Email Opt 1=Yes

### Email Opt 2=Yes

### Email Opt 3=No

Time=Apr. 17, 2008 at 4:24 PM Greenwich time plus 5 hours
D-Pres Data fields contain the following data in separate fields:

### Doctor ID=500755

NDC=49884-246-01 (the NDC for Carisoprodol and Aspirin from PAR Pharmaceutical, Inc.)

### Drug Manufacturer: PAR Pharmaceutical, Inc.

### Drug Expiration Date: Jun. 1, 2009

### Dose=200 Mg

### Quantity=60

### Refills=3

Remaining refills=3 (new prescription, not yet filled)

### Addl Info Printed=No

### Addl Info Emailed=Yes

Instructions=“Take 1 capsule orally not more than every 12 hours.”
Refill Reminder 1 emailed: yes.
Refill Reminder 2 emailed/rcvd: no, no
Refill Reminder 3 emailed/rcvd: no, no

### Email 1 Rcvd=yes

### Email 2 Rcvd=no

### Email 3 Rcvd=no

### Gender=Male

### Age=57

Pill count=60
zip code=22304 (patient's zip code)
Demographic 1=Alexandria (Patient city of residence)
Demographic (i)=Generally optional additional demographic information, limited in the aggregate of all demographic information, to information insufficient to uniquely identify the patient.

Processing Instructions Code 240 preferably contains instructions for HR CS 30 to apply the criteria in table 210 to the data in table 220 and store the results in table 230. In addition, Processing Instructions Code 240 also preferably contains instructions for HR CS 30 to transmit to each PM(i) CS the ENC PID and Payload data for records in table 230 associated with that PM(i) CS.

Reporting Instructions Code 250 preferably provides for reports to operators of HR CS 30 on performance and accountings.

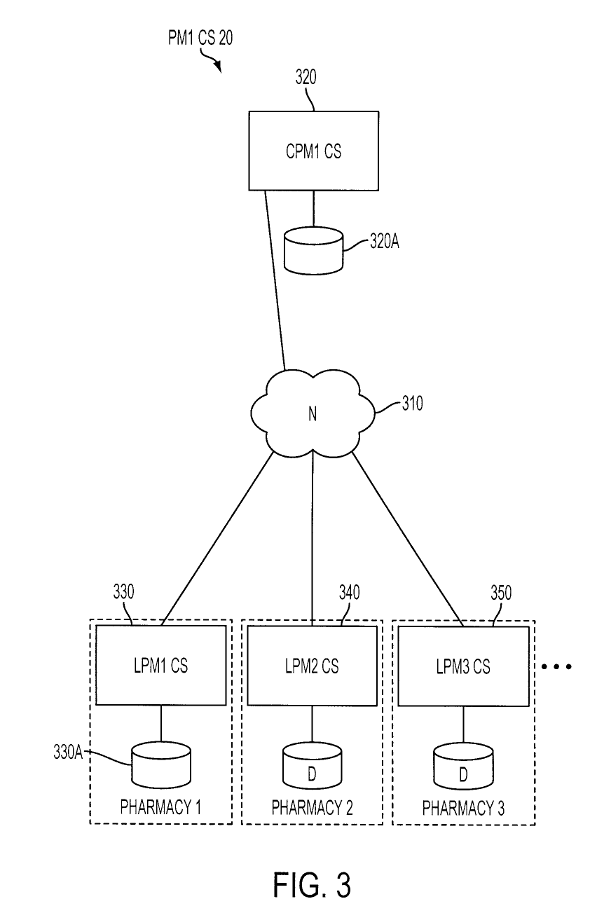

FIG. 3 is a schematic of one embodiment of PM1 CS 20 of FIG. 1. FIG. 3 shows PM1 CS 20 comprising Network 310, central CPM1 CS 320, and a plurality of local LPM CSs, including as shown LPM1 CSs 330, 340, and 350, each of which is preferably located in or near corresponding pharmacy 1, pharmacy 2, and pharmacy 3. Each LPM CS includes an associated database, such as LPM1 database 330A for LPM1 CS 330.

In other embodiments, CPM1 CS 320 has network connection or terminal connection to the pharmacy I/O devices, printers, terminal entry stations, and the like, and performs some or all processing operations for each pharmacy store. That is, pharmacy data processing and data I/O operations may be managed by one CPM CS remote from all but at most one of the actual pharmacy stores. Network 310 may be a private network or the Internet, or a combination thereof. Optionally, PM1 CS may consist of only one LPM CS.

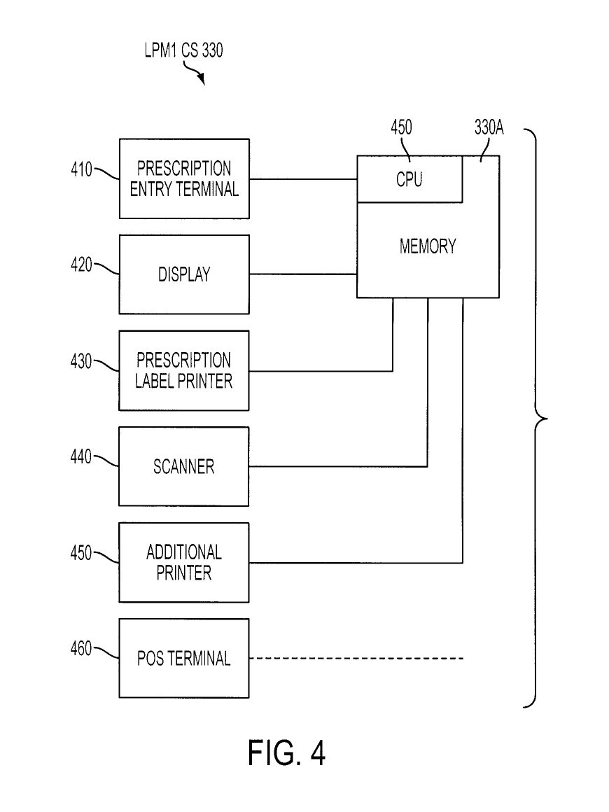

FIG. 4 is a schematic of LPM1 CS 330. FIG. 4 shows LPM1 CS 330 comprising Prescription Entry Terminal 410, Display 420, Prescription Label Printer 430, Scanner 440, and Additional Printer 450, and computer core elements 450.

FIG. 4 also shows POS terminal 460 as optionally not communicating with PM1 CS 330.

Prescription Entry Terminal 410 is used by pharmacy personnel or optionally patients or their representatives to input data relating to a prescription.

Display 420 may be used to display entered prescription information.

Prescription Label Printer 430 is a printer that prints prescription labels. A prescription label is a document that contains an identification of the prescription and may contain related information. Identification of the prescription included identification of drug, dosage, and use. Related information includes patient identifier, bar code identifying the prescription, and any other additional information Scanner 440 is a bar code scanner useful for identifying prescription orders associated with bar codes.

Additional Printer 450 is a printer optionally desirable for printing anything besides prescription labels, such as additional drug information and patient advice. Optionally, this information may also be printed by the prescription label printer.

Computer core elements 450 include at least a CPU and associated memory 330A.

CPM1 CS 320's database 320A may contain copies of databases 330A and the corresponding databases shown for all other pharmacies networked to CPM1 CS 320. And it may perform the storage and code functions for each pharmacy which are described below for LPM1 CS. Discussion herein of PM CS refers to any embodiment of PM1 CS 20; whether containing a CPM CS and many LPM CSs, a single LPM CS, or a single CPM CS. A functional difference between a cental and plurality of local PM CSs is that data is transmitted from each local to the central, and data may transmit from the central instead of each local, and to the central, instead of each local, in communications with one or more of HR CS 30 and Email1 CS 20′.

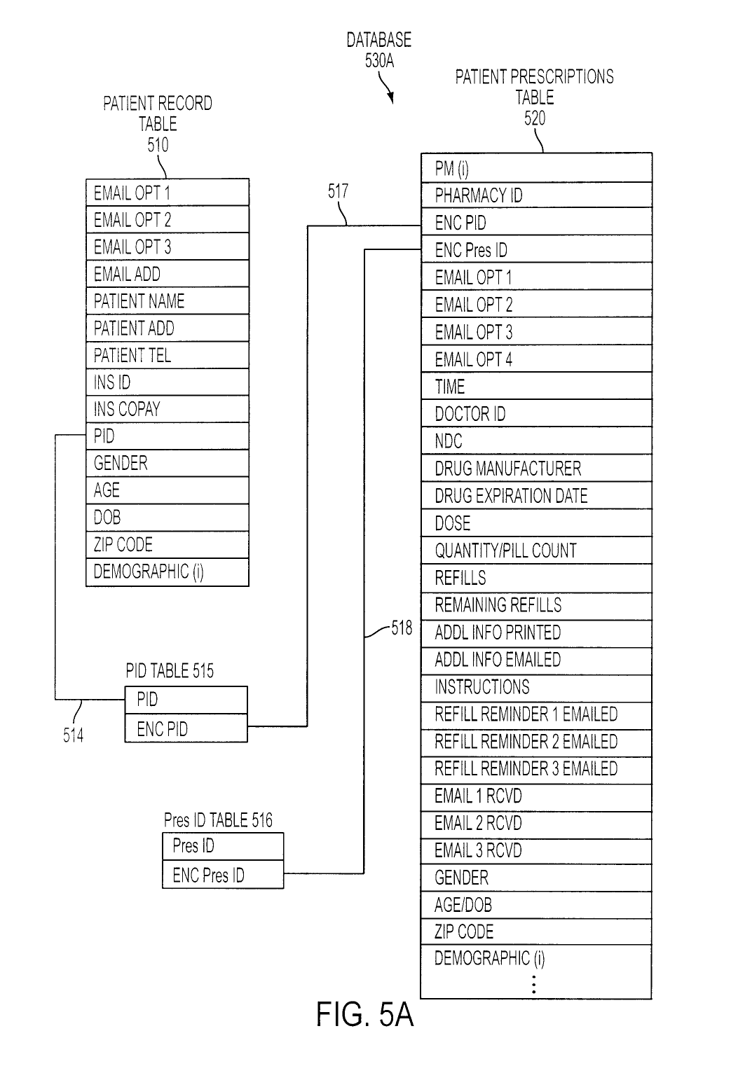

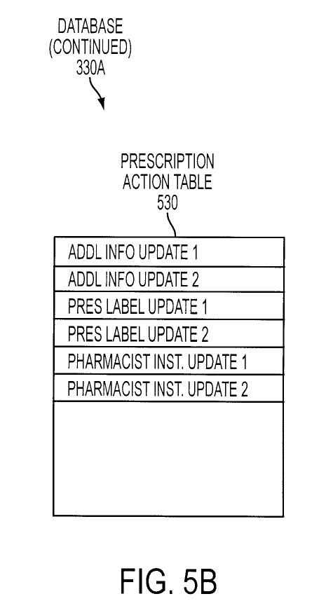

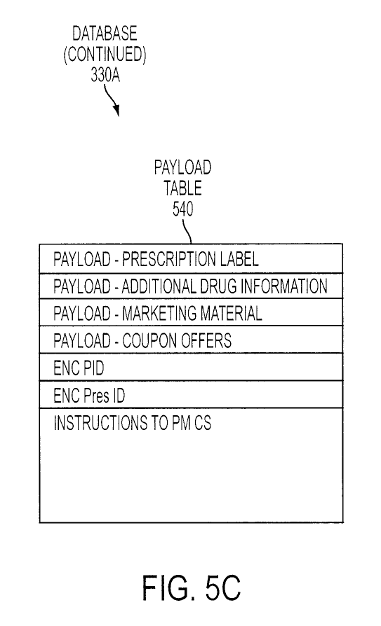

FIG. 5A and FIG. 5B are schematics in design view of portions of database 330A.

FIG. 5A shows portions of Database 330A in design view. FIG. 5A shows a portion of Database 330A includes Patient Records Table 510, PID Table 515, Pres ID table 516, Links 517, 518, and Patient Prescription Records Table 520.

FIG. 5B shows Prescription Action Table 530. Patient Records Table 510 generally contains data fields relating to the patient and not relating to a specific prescription order. PID Table 515 and Pres ID Table 516 relate unencrypted PIDs and Pres IDs to encrypted PIDs and Pres IDs. Prescription Records Table 520 generally contains data relating to a prescription order other than PHI data. Prescription Action Table 530 generally contains instructions indicating preferences in response to certain data, defined for a particular pharmacy, so that corresponding PM CS reacts as desired in any particular pharmacy, in response to pharmacy orders. Table 530 may be stored either in the PM CS or in the HR CS, or both, and used by the PM CS and the HR CS to define instructions and data for the corresponding pharmacies managed by the PM CS.

Patient Records Table 510 has fields logging whether the patient has opted in to obtaining information by email, such as information required by law, such as HIPAA information, and patient email address. These fields are Email Opt 1; Email Opt 2; Email Opt 3; which are fields logging the patients selections of what information should be sent via email; and Email Add for patient email address. For example, in Email Opt1, patients may opt in to receiving additional drug information via email, but may also specify in Email Opt2, to continue to receive printed versions of that information with each prescription fill. Alternatively, Email Opt fields, such as Email Opt 1, Email Opt 2, and Email Opt 3 may contain options for receiving or not receiving additional drug information with the initial prescription fill, first refill, and second refill, respectively. Alternatively, Email Opt fields may contain options for the patient to specify whether to receive notifications when refills are due, and whether to receive marketing communications with those emails.

Table 510 also contains additional fields identifying how to contact the patient, including: Patient Name for the patient's name; Patient Add/Tel for the patients address and telephone contact information. Table 510 may also contain insurance information for the patient including: Ins ID for the patients insurance policy identification; Ins Copay for insurance payment information associated with the insurance policy.

Table 510 preferably contains a field for a PID other than patient name. However, name may be used for PID.

PID Table 515 contains fields for PID and ENC PID (encrypted PID).

Pres ID Table 516 contains fields for Pres ID (prescription ID) and ENC Pres ID (encrypted prescription ID).

Use of an encrypted Prescription ID, ENC Pres ID, to maintain patient privacy (or alternatively a de-identified Pres ID, DI Pres ID in which certain data is removed from the Pres ID, or both) is optional. As noted above, a Pres ID is generally considered PHI. Therefore, legal compliance may require that only a de identified or encrypted version of a Pres ID be sent to the HR CS or elsewhere, instead of the PM CS's Pres ID. Again, Pres ID does not identify a patient; is not, except within PM1 CS 20, linked to patient name or patient contact data. Hence, discussion of use of ENC Pres ID or DI Pres ID instead of Pres ID, and vice versa, may be substituted throughout this disclosure. Further, storage in PM1 CS 20 of associations of PID to ENC PID, and Pres ID to ENC Pres ID is optional when PM1 CS 20 stores the algorithms for coding the encrypted IDs and also decoding the encrypted IDs.

Links 517, 518, provide a relational database link, or corresponding association in a flat files representation, between the ENC PID and ENC Pres ID fields in tables 515, 516, and 520.

Prescription Records Table 520 includes fields:

PM(i), for storing an identification of the PM CS;

Pharmacy ID, for storing an identification of the pharmacy (or alternatively the LPM CS when the LPM CS controls operations in only one pharmacy);

ENC PID, for storing the encrypted PID;

ENC Pres ID, for storing a encrypted version of the prescription ID (alternatively, for storing the Pres ID);

Email Opt1, for storing an indication whether the client has agreed to receive via email additional drug information via email;

Email Opt2, for storing an indication whether the client has agreed to receive via email reminders to pick up an ordered prescriptions;

Email Opt3, for storing an indication whether the client has agreed to receive via email additional marketing information;

Email Opt4, for storing an indication whether the client has agreed to receive via email coupon offers, that is offers for discount for purchase of specified products;

Time, for storing time of prescription order;

Doctor ID, for storing ID of doctor authorizing prescription;

NDC, for storing national drug code for prescribed drug;

Drug Manufacturer, for storing name of the drug manufacturer;

Drug Expiration date, for storing expiration date of the drug used to fill the prescription;

Dose, for storing dose specified by the prescription;

Quantity/Pill count, for storing quantity or pill count (these may be separate fields) contained in each fill of the prescription;

Refills, for storing the number of refills authorized by the prescription;

Remaining refills, for storing the number of authorized refills remaining for the prescription;

Addl Info printed, for storing an indication whether additional drug information, such as the type of information required by HIPAA, was printed and delivered with delivery of the prescription;

Addl Info Emailed, for storing an indication whether additional drug information was emailed to the patient's email address, and/or whether a response was received from the patient indicating that additional drug information emailed to the patient's email address was received by the patient;

Instructions, for storing instructions for the patient regarding administering the prescription;

Refill reminder 1 emailed, for storing an indication whether a reminder for the first refill of a prescription was emailed to and/or received by the patient;

Refill reminder 2 emailed, for storing an indication whether a reminder for the second refill of a prescription was emailed to and/or received by the patient;

Refill reminder 3 emailed, for storing an indication whether a reminder for the third refill of a prescription was emailed to and/or received by the patient;

Email 1 Rcvd, for storing an indication whether confirmation by the patient of receipt of an email containing additional drug information for the drug specified in the prescription.

Email 2 Rcvd, for storing indications whether the patient requested second fill (first refill) of the prescription via email, and time and date of the request, and anticipated time and date of arrival of a person at the pharmacy to pick up the prescription refill (each of these data elements may be a separate field in Table 520); and

Email 3 Rcvd, for storing indications whether the patient requested third fill (second refill) of the prescription via email, and time and date of the request, and anticipated time and date of arrival of a person at the pharmacy to pick up the prescription refill (each of these data elements may be a separate field in Table 520).

Where email ordering is an option, fields may also exist for storing indications whether the patient requested the prescription fill in the first instance via email. Patient Prescription Table 520 may also include fields for demographic data that does not uniquely identify the patient, such as fields for gender, age, zip code, etc. These fields optionally also exist in Patient Record Table 510; pharmacists directions; boolean indicating whether printing of prescription and newsletter are simplex or integrated; payer (third party payer name or “CASH” if paid by customer); payer code (third party payer code or “CASH” if paid by customer); payer's processor control number; bank identification number; legal relationship between agent and principal for the prescription; insurance policy group ID; and insurance policy plan ID; daily supply quantity; number of days supply; original fill date; expiration of prescription date.

Table 520 preferably also has fields for patient language preference (such as English or Spanish); name mask flag field indicating printing “Valued Customer” instead of patient name (which may optionally reside in Table 510, or in both 510 and 520); opt out flag indicating patient does not want information based upon patient's record; whether to print prescription number on newsletter.

Table 520 may optionally also store message version number; state code for store location; division ID to aid in triggering division specific programs; store ID to aid in triggering store specific programs; national council for prescription provider ID; transaction sequence number generated by local CS; alpha numeric associated with a drug monograph.

Table 520 may also contain a boolean indicating whether to print HIPAA required additional drug information for a prescription; payer (third party payer name or “CASH” if paid by customer); payer code (third party payer code or “CASH” if paid by customer); payer's processor control number; bank identification number; legal relationship between agent and principal for the prescription; insurance policy group ID; and insurance policy plan ID.

In a preferred embodiment, an additional table is generated from table 520 by including only those data fields that do not identify the patient; those that are PHI compliant. The PM CS preferably queries that derived table to generate a de identified prescription record for transmission to the HR CS. However, any embodiment in which information uniquely identifying the patient is not sent to HR CS 30 is within the scope of the conceived invention.

Link 514 links Patient Record Table 510 via the PID fields to Patient Prescription Table 520 via the ENC PID fields. That link, or execution of the encryption and decryption algorithms stored in the PM CS enable linking of data in tables 510 and 520 such that PM CS can identify of the patient for each patient prescription record.

The description of FIG. 5A is only exemplary. In one embodiment, the patient and prescription records in database 330A store the following fields:

ndc—national drug code
ndc/age/gender—Combination of national drug code, patient age, and patient gender
ndc/refill—Combination of national drug code, NDC, and number of refills.
ndc/new—Combination of NDC and whether this is a new and not yet filled prescription.
ndc/PillCount—Combination of NDC and number of pills per prescription fill.
ndc/refill#—Combination of NDC and the number of the number of refills already filled or number of the currently requested refill of the prescription.
ndc/refills remaining—Combination of NDC and number of remaining refills authorized by the prescription.
age/gender—Combination of age and gender.
payer—Name of payer entity ID, that is, insurance company.
payer/ndc—Combination of payer entity ID and NDC
payer/age/gender—Combination of payer entity ID, patient age, and patient gender
payer/ndc/age/gender—Combination of payer entity ID, NDC, and gender
payer/ndc/refill—Combination of payer entity ID, NDC, and refill number.
payer/ndc/new Combination of payer entity ID, NDC, and that the prescription has not yet been filled.
PID—As defined.
ndc/patient—Combination of NDC and patient identifier
ndc/new/patient—Combination of NDC, that the prescription is a new prescription that has no filled prescriptions, and patient identifier.
ndc/refill/patient—Combination of NDC, number of the refill, and patent identifier.
ndc/refill#/patient—Combination of NDC, number of the refill, and patient identifier.
ndc/age/gender/refill/new—Combination of NDC, patient age, patient gender, number of the refill, and whether the prescription has not yet been filled.
ndc/bin no—Combination of NDC and bin number.
Refill/new/patient ID—Combination of refill number, whether the prescription is a new prescription that has not been filled, and patient identifier.

FIG. 5B shows a portion of Database 330A including Prescription Action Table 530. Prescription Action Table 530 contains Boolean logic values for specifying how the PM CS uses the information stored in the Patient Prescription Table 520 to modify pharmacy operations relating to a prescription and its refills. Prescription Action Table is a useful way to describe how different pharmacies react to the same inputs relating to a prescription. Prescription Action Table 530 includes fields Addl Info Update1; Addl Info Update1; and Addl Info Update1 for specifying actions by the PM CS in response to data indicating (1) whether additional information about a drug specified in a patient's prescription was or was not received by the patient prior to the first order for the prescription, and (2) whether that receipt was via email or print attached to the filled prescription order.

For example, Addl Info Update1 may store a value specifying that, if the patient was sent an email with the additional drug information, not to print that information in the pharmacy when fulfilling the prescription order, or, to in any case print that information in the pharmacy when fulfilling the prescription order. In this case, there is no reliance on whether there is an indication that the patient in fact viewed the additional information; only that it was sent to the specified email address.

For example, Addl Info Update1 may store a value specifying that, if the patient received an email with the additional drug information, not to print that information in the pharmacy when fulfilling the prescription order, or, to in any case print that information in the pharmacy when fulfilling the prescription order.

For example, Addl Info Update2 may store a value specifying that, if the patient was sent, or the patient received, an email with the additional drug information and also an advertisement or coupon, not to print that advertisement or coupon in the pharmacy when fulfilling the prescription order, or, to in any case print that advertisement or coupon (and provide it to the consumer) in the pharmacy when fulfilling the prescription order.

For example, Addl Info Update2 may store a value specifying that, if the patient was sent, or the patient received, an email with the additional drug information and also an advertisement or coupon, to display on the POS terminal when the prescription order, or its refill is presented for payment, the existence of the advertisement or coupon.

For example, Pharmacist Inst. Update1 may store a value specifying that, if the patient was sent, or the patient received, an email with the additional drug information and also an advertisement or coupon, to display on Display 420 during filling of the prescription, the advertisement and existence of the coupon. Optionally, this specification may include instructions for the pharmacist of pharmacy clerk to relay the information to the person receiving the prescription for the patient.

For example, Pharmacist Inst. Update1 may store a value specifying that, if the patient was sent, or the patient received, an email with the additional drug information and also an advertisement or coupon, to print on printer 450 or printer 430, during filling of the prescription, the advertisement and coupon so that they are provided in paper form to the person receiving the prescription for the patient.

For example, Pres Label Update1 may store a value specifying that, if the patient was sent, or the patient received, an email with the additional drug information, to modify the print of the prescription label to specify email notification of that information. For example, printing “HIPAA drug information sent by email.” Optionally, that print would include the email address and/or date and time of the email, and/or subject line of the email, so that the patient could check to confirm the email address was correct, and search and find the email in the patient's email database.

For example, Pres Label Update2 may store a value specifying that, if the patient was sent, or the patient received, an email with the additional drug information, to modify the print of the prescription label to also specify a subset of the additional drug information, such as a most critical side effect. Optionally, that print would include the email address and/or date and time of the email, and/or subject line of the email, so that the patient could check to confirm the email address was correct, and search and find the email in the patient's email database.

Thus, Prescription Action Table 530 specifies optional changes to pharmacy procedure based upon sending and confirmation of receipt of emails to patients containing additional information about the drug contained in their prescription order, and optional changes to pharmacy procedure based upon sending and receiving of additional marketing materials in such an email.

Optionally, each PM CS may be programmed to perform whatever logic would otherwise be stored in a Prescription Action Table.

In one alternative to Prescription Action Table 530 being stored in the PM CS database, for each PM CS (that is, in association with an identifier of the PM CS from which the data originated) one Table 530′ containing some or all of the information noted above for Table 530 is stored in the HR CS 30 database 30A. In this alternative, HR CS 30, Payloads include the results of running code executing the options in Table 530′. That is, HR CS 30 runs code to determine and provide one or more of Addl Info Updates, Pres Label Updates, and Pharmacist Inst. Updates in the Payload that it sends back to the PM CS. In this alternative, the PM CS executes code implementing for example instructions to its pharmacists based upon the Payload it receives from HR CS 30.

FIG. 5C shows Payload Table 540 in Database 330A of PM1 CS 20. Payload Table 540 contains data transmitted from HR CS 30 back to PM1 CS 20. Payload Table 540 includes fields for: Payload—Prescription label; Payload—Additional Drug Information; Payload—Marketing Material; Payload—Coupon Offers; ENC PID; Pres ID (which may be an encrypted or de identified version of the data for Pres ID in PM1 CS 20); and Instructions to PM CS.

While rendered in FIG. 5C as a table, the Payload received by the PM CS may also be stored in flat files or folders storing one file in each folder for each data field element.

The Payload Prescription Label field may contain a printer file for specifying to Prescription Label Printer 430 printing of some or all of a prescription label corresponding to the prescription. Preferably, the Payload Prescription Label field does not contain all of the data to be included in a printed prescription label, for example, not including the PID, patient name, or other information uniquely identifying the patient. In this embodiment, the PM CS stores code and specifications to merger the data in Payload Prescription Label field with other data elements necessary to print the prescription label, at least including in that merging process, patient name.

The Payload Additional Drug Information field preferably stored information about the drug in the prescription required for regulatory compliance, such as HIPAA compliance. It may also include additional information about the drug, such as a Drug Monograph.

The Payload Marketing Material field preferably stores information about related medicines, perhaps medicines competing with the medicine contained in the prescription. It may also contain information about clinical trials and solicitations to enroll in studies.

The Payload Coupon Offers field stores information about offers for discounts on purchase of products.

The instructions to PM CS field stores instructions to the PM CS for processing the prescription, such as whether to print on the prescription label or whether to notify the pharmacy personnel that the patient received HIPAA compliance material via email, whether email Payload information to the patient, whether to email or print any of the Payload information for the patient.

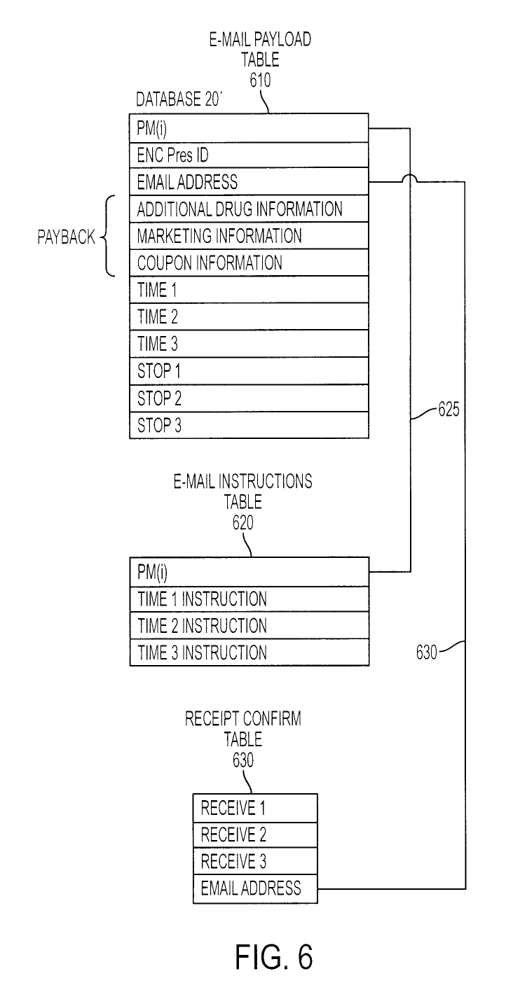

FIG. 6 is a schematic showing tables in Email CS 20's Database 20′. FIG. 6 shows Email Payload Table 610, Email Instructions Table 620, and Receipt Confirmation Table 630.

Email Payload Table 610 contains fields including PM (i) for a pharmacy CS identification; ENC Pres ID, for the encrypted prescription ID, email address for email address of the patient; and patient Payload fields, including Additional Drug Information; Marketing information; and Coupon information.

In addition, Email Payload Table 610 may contain time fields Time1, Time2, and Time3, etc. The time fields are for specifying to the Email CS when emails should be sent.

In addition, Email Payload Table 610 may contain stop fields for specifying if scheduled emails should not be sent. Fields Stop1, Stop2, Stop3 contain boolean values indicating whether email transmission should occur. For example, assume a patient refills a prescription before the Email CS sends a reminder to the patient to do so. In that case, the PM CS might send an update to the Email CS with a stop instruction, instructing the Email CS to stop or not send an email reminding the patient to refill the prescription. Such stop instructions may be stored in the Stop fields associated with an email address and prescription order.

Email Instructions Table 620 includes fields for PM(i) linked via link 625 to the same named field in table 610, and instructions for actions to take at times 1, 2, and 3, in fields Time1 Instruction, Time 2 Instruction, and Time 3 Instruction.

Receipt Confirm Table 630 contains indications that the Email CS received confirmation that the patient received a corresponding email, in fields Receive1, Receive2, and Receive3. These confirmation may be a result of voluntary action taken by the recipient to confirm receipt of an email, such as by sending a reply email or by clicking a specified link in an email. Alternatively, they may be computer code generated by code instructing the recipient client CS to automatically respond acknowledging receipt of the email, or receipt confirming activating a link in such an email. Link 635 links the Email Address fields in tables 610 and 630.

Email CS 20 functions to send emails based upon the data it receives from the PM CS, and then preferably transmit to the PM CS any confirmations of receipt it obtains from the patients to which it sends emails. Alternatively, the code or instructions in the emails that Email CS 20 sends to patients may instruct the patients or their client CSs 50, 50A, 50B, to transmit a reply directly to the PM CS. In any case, the PM CS updates its records regarding transmission and receipt of emails to patients, such as by updating fields in Patient Prescriptions Table 520. The PM CS may use this updated information as described above to alter actions it takes to fulfill the prescription.

In practice, preferably neither HR CS 30 nor Email1 CS 20′ receive information identifiable to a particular patient. Alternatively, if email address is deemed identifiable to a particular patient, Email1 CS 20′ is within the firewall and security policies for HR CS 30. PM1 CS 20 may assume the functions and data structures of Email1 CS 20′ and therefore Email1 CS 20′ is not necessary to the concept of this invention.

Preferably, to the extent that the PM CS sends demographic data to the HR CS, the PM CS runs code to de-identify that demographic data, for example limiting data that could be used to narrow down the potential patient to a small number of people. Such procedures are disclosed in the applicant's patent U.S. Pat. No. 7,309,001 titled “System to provide specific messages to patients”, the teaching of which, particularly those teachings dealing with de-identification of a patient record, are incorporated herein by reference.

In a related embodiment, the HR CS may be programmed to respond to a newly received de identified prescription record by performing two temporally separated criteria processing functions.

First, the HR CS may promptly respond to receipt of the newly received de identified prescription record, by generating a first Payload of additional drug information and transmitting that information back to the PM CS. This response may be automatic and in response to receipt, or queuing on a short period, such as every 5 minutes. Second, the HR CS may respond on a more delayed periodic schedule, by run criteria requiring access of historical records associated with the same ENC PID or Pres ID (or DI Pres ID or ENC Pres ID), and then transmit a second Payload back to the PM CS based upon this additional processing. This delayed schedule may for example be hourly or daily. In other words, the HR CS executes a two step process. First, it provides additional drug information as promptly as feasible to the PM CS so that it is available for the PM CS to use to notify the patient. Second and subsequently, it determines any changes to the additional drug information, any marketing information, and any incentive offers to associate with the ENC PID and/or its Pres ID, and transmits that information back to the PM CS.

Further, the HR CS may generate a new Payload for printing of a message to be given to the patient when the patient picks of the filled prescription in the pharmacy, based upon patient responses to prompts embedded in an electronic communication to the patient. For example the electronic delivery of additional drug information in response to receipt by the PM CS of a prescription, or a reminder for refill of such a prescription, may also include prompts to the patient whether they also desire health and wellness information, want to opt in to receive marketing communication, and/or want to opt in to receive purchase incentive (coupon) offers. Those prompts may be accompanied by client side code or server side code in case of a web page which results (eventually) in transmission of patient responses associated with an identifier (ENC PID, Pres ID, DI Pres ID, or ENC Pres ID) receive at the HR CS. The HR CS may then process criteria whose Payloads correspond to the opt in selections of the patient, and forward the resulting Payloads information to the corresponding PM CS. The PM CS responds by presenting the additional information to the patient such as by printing the information in the pharmacy and providing it to the patient when the patient receives their filled prescription, sending the patient another electronic transmission containing that information, both, displaying it to the patient in the store, are even transmitting it to another device (cell phone or PDA or land line phone voice mail) associated by the PM CS with the patient.

One sequence of events corresponding to an implementation of the invention is as follows.

The physician provides a patient with a prescription.

The patient provides the prescription to the pharmacy.

At the pharmacy the patient opts in to receive email communications for the patient's prescriptions, marketing communications, and coupon offers.

The patient's prescription data and opt in selections and email address are entered into the PM CS database via a PM CS terminal.

The PM CS transmits a de identified version of the first prescription to the HR CS.

Some time later a second prescription for the patient is submitted to the PM CS with orders to fill the prescription.

The PM CS generates a de identified record for the second prescription and transmit that to the HR CS.

The HR CS promptly runs first criteria on the de identified second prescription record resulting associating a first Payload with the identifier for the second prescription record for the patient, and transmits that first Payload back to the PM CS.

Several minutes or hours later, the HR CS identifies all records associated with the same identifier as the second de identified prescription record, which includes the first de identified prescription record. The HR CS runs criteria that include filers based upon when prescriptions were written and/or criteria filtering for more than one prescription, to determine a second Payload for the patient, and transmits that second Payload to the PM CS.

Upon receipt of the first Payload, the PM CS or its Email CS sends an email to the email address for the patient, and it queues the additional drug information for printing at the time of printing of the label for the prescription. However, if the PM CS receives confirmation of receipt of the email, it removes the additional drug information from the queue for printing when printing the prescription label.

Alternatively, the PM CS queues the additional drug information for printing when it receives entry of an indication that the filled prescription is being conveyed to the patient, such as an entry in a PM CS terminal. It also notifies the terminal, that is the person monitoring the terminal, to fetch and provide to the patient the additional drug information and prints on a pharmacy printer the additional drug information. However, if the PM CS receives confirmation of receipt of the email, it removes the additional drug information from the queue for printing when printing the prescription label and it removes changes its instruction for display at the terminal of the person conveying filled instruction to patients to instead display that the additional drug information was previously received by the patient.

The inventors recognized that communicating with the patient via an electronic address during the course of filling a prescription provides additional opportunities to advise the patient and influence the patient's decisions. Each communication from the patient is an opportunity to obtain input from the patient which can be analyzed and then used to further customize and target subsequent messages to the patient.

A communication from the patient includes a determination that the patient read or expressed interest in content in a communication to the client. For example, an determination that a client opened an email file, and a determination that a client activated a hyperlink in a file including characterization of the hyperlink by text displayed in association with the hyperlink indicating the subject matter of the URL to which the hyperlink points.

Preferably, subsequent customized and targeted emails to the patient during the process of prescription order, fill, and refill, including notifications that a prescription is ready for pickup, and notifications to refill, contain content which depends on patient response to prior communications during that process. These communications include in temporal sequence:

(1) a communication containing the additional drug information for a prescription;

(2) at least one communication containing the notice that the prescription is awaiting pickup (filled),

(3) a communication at pickup at the pharmacy when the prescription is picked up by the patient;

(4) additional communications to remind the client when it is time to refill a prescription followed by communications (2) and (3).

As noted, the foregoing communications to the patient may also include additional marketing content, and health advisory content, and code embedded in the communications for transmitting information to the PM CS or elsewhere upon patient action on their client CS.

In one embodiment content of subsequent communications is based upon confirmation that the client received or opened an email from the PM CS. That confirmation notification may be provided in a manner well known in the art, such as by scripts embedded in the email sent to the patient's electronic address.

For example, a first email communication to a patient's electronic address after the patient orders a prescription may contain additional drug information for the prescribed drug, and also marketing information indicating benefits of drug X, and also a list of questions for example including questions about drug X or the patient's related medical conditions. The first email communication may contain a hyperlink to a URL and text indicating that more information about drug X may be found at the hyperlinked URL. The first email may contain code instructing the client CS to transmit back to the PM CS notification when the email was opened, when a link in the email was activated, an identity of the email, and an identity of the activated hyperlink. The PM CS or its Email CS may configure the email to include identity codes for the email linked to the PID or other patient identifier stored in the PM CS. The PM CS or its Email CS may configure the email to include identity codes for each of the hyperlinks in the email. The identity of the hyperlinks may be stored in a table in the PM CS or in the HR CS. The first email may refer to any product, product Y for example, instead of drug X, or to plural products and drugs.

The first email and each subsequent email to the patient's electronic address may include data identifying the email and hyperlinks in the email activated by the patient, and code to transmit back to the PM CS or the HR CS or both the identify of the email in response to its being opened on the patient's client CS, and the identities of the hyperlinks in response to their activation by the patient clicking on them.

Rules may be stored in either the PM CS or the HR CS or both specifying what information to include in a subsequent communication to the patient depending upon which links in prior emails to the patient were activated and which emails were opened.

A second email communication indicating the prescription is ready for pickup in the pharmacy may also contain a coupon or incentive offer for subject matter in which the patient expressed interest in the first email, such as interest in drug X. The second communication may contain a link to online purchase drug X, or more information about drug X, or both. The second communication may contain a link for the patient to click to indicate the patient's desire to purchase drug X in the store when picking up of the filled prescription, in which case a store clerk may respond to that indication by physically associating a item of drug X with the prescription order for the convenience of the customer. The second email may refer to any product, product Y for example, instead of drug X, or to plural product and drugs.

The second email may contain code instructing the client CS to transmit back to the PM CS notification when the second email or any other of the emails is opened, when a hyperlink in the second email or any other of the emails is was activated, identity of the email (to which the PID may be associated in the PM CS), and identity of each activated hyperlink.

Subsequent communications to the patient may be based upon whether the PM CS received an indication that the client was interest in content linked in an email, such as by receiving the data indicating that the patient clicked a hyperlink having text indicating that the hyperlink was for said content. The electronic communication to the electronic address for the patient preferably includes code that does any one or more of the following: sends a message to the PM CS that the link was clicked in association with a patient ID; sends a message to the HR CS that the link was clicked in association with the ENC PID or ENC Pres ID or a de identified version of the PID or Pres ID; the ID previously sent by the PM CS to the HR CS (in which case the ID was included in the email sent to the client). In either case the HR CS responds by sending, or has already provided, to the PM CS, instructions how to respond to such an indication of interest; for example by providing to the patient in a subsequent communication a coupon (incentive offer) for purchase of the product or drug for which the patient clicked the link (objectively expressed interest).

If the code in the email on the client CS sends a message to the HR CS that the email was opened, or that a link was clicked. it also preferably also sends the encrypted or de identified identifier for PID or Pres ID, and sends the identity of the email and the identify of the links in the email activated by the client CS. The HR CS may respond by determining a new Payload and forwarding that new Payload information to the PM CS in association with the identity of the email, the identity of the links clicked, or preferably the encrypted or de identified version of the PID or Pres ID.

The PM CS may store a table containing a matrix of the possibilities for patient interest as determined by patients opening emails and activating hyperlinks in the emails, and predetermined Payloads to send back to the client in a subsequent communication. Or the PM CS may forward each data input from each electronic communication received from the patient's client CS and the content of the email sent to the client CS resulting in that data, to the HR CS, which in turn determines Payloads and transmits them back to the PM CS for subsequent communication to the patient.

In order to provide customized messaging depending upon patient responses, preferably, De Identified Prescription History Table 220's fields D-Pres Data also include fields indicating status of communications to patients, such as the following:

whether an electronic communication (such as an email) to the patient's email address was opened, and an identity of that electronic communication;

whether a hyperlink (here after “link”) in the email to the patient's email address was activated on a client CS and an identity of that link and the identity of the electronic communication.

The electronic communication identities and link identities may be generated by the PM CS, by its email server CS, or even by the PM CS as part of Payloads.

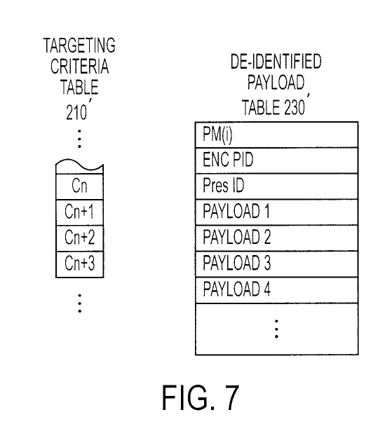

FIG. 7 shows alternative De Identified Payload Table 230′ and part of alternative Targeting Criteria table 210′ for customized targeted messaging.

Table 210′ differs from Table 210 only by including criteria relating to whether emails involved in the prescription process were opened, and whether links in emails were opened. For example, Table 210′ may include fields for the following criteria: C(n), indicating whether Additional Drug Information (ADF) was sent to the patient's email address; C(n+t), indicating whether the ADF email was opened, C(n+2), indicating whether a link in the ADF email was activated (clicked, instructing a web browser to request a file having a URL); C(n+3), indicating whether an offer for a coupon (incentive offer) was sent to the electronic address.

Table 230′ differs from Table 230 only in additional sequentially numbered Payload fields. These additional Payload fields are specifically useful in connection with methods of sequentially communicating with patients in which subsequent communications during the course of filling a prescription order depend upon the aforementioned fields indicating status of prior communications to the patients. These system may be designed to provide Payload fields: Payload 1, Payload 2, Payload 3, Payload 4, etc., to the patient, in response to positive indication by corresponding criteria fields C(n) to C(n+3). The Payload fields preferably include the corresponding text, URL's and optionally client side code for notifying the PM CS of one or more of: when the electronic communication was opened, when the embedded links were clicked, and the identifies of the embedded links.

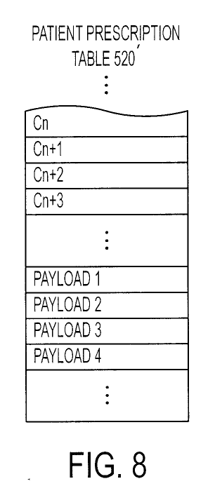

FIG. 8 shows alternative Patient Prescription Table 520′. Table 520′ contains the same fields as Table 520, and also the “C” criteria values an the corresponding Payloads. Those Payloads are of course provided by the HR CS.

In summary, client side code in email sent by the PM CS or its Email CS to the patient's electronic address may instruct the client CS to transmit new data indicating opening of emails and activating of links therein in association with data enabling the PM CS or HR CS to associated the new data with existing data associated with the same patient. That allows the PM CS to have a dialogue with the patient during the course of filling a prescription that enables targeting of communication to the patent based upon feedback from the patient.

We claim:

1. A method of limiting printing of information relating to a pharmacy prescription, comprising:
receiving, in a PM CS, an electronic address for a patient;
receiving, in said PM CS, an order for a prescription for said patient;
receiving, in said PM CS, an authorization from said patient to send said patient electronic communications containing additional drug information to said electronic address;
generating, in said PM CS, a prescription record for said prescription;
generating, in said PM CS, at least one of an encrypted patient identifier, ENC PID, for said patient and a prescription record identifier, Pres ID, for said prescription record;
including, in said PM CS, in said prescription record, at least one of said ENC PID and said Pres ID;
transmitting from said PM CS to a HR CS a de identified prescription record;
applying, in said HR CS, criteria to at least said de identified prescription record;
said applying resulting in determining, in said HR CS, a Payload;
wherein said Payload contains additional drug information for a drug specified by said prescription;
associating said Payload with at least one of said ENC PID and said Pres ID;
transmitting, from said HR CS to said PM CS, said Payload in association with at least one of said ENC PID and said Pres ID;
transmitting, from one of said PM CS and an Email CS to said electronic address for said patient said additional drug information contained in said Payload;
determining, in said PM CS, an additional drug information transmission determination indicating either whether said additional drug information was transmitted to said electronic address for said patient or whether said additional drug information was received by said electronic address for said patient;
displaying, in said PM CS, instructions for filling said prescription in a pharmacy associated with said PM CS; and
printing, in said PM CS, said additional drug information for the filled prescription, if said additional drug information transmission determination does not indicate that said additional drug information was transmitted to or received at said electronic address for said patient.

2. The method of claim 1 wherein said generating, in said PM CS, at least one of said ENC PID and said Pres ID comprises generating said ENC PID.

3. The method of claim 1 wherein said generating, in said PM CS, at least one of said ENC PID and said Pres ID comprises generating said Pres ID.

4. The method of claim 1 wherein said Pres ID is encrypted.

5. The method of claim 1 wherein said generating, in said PM CS, at least one of said ENC PID and said Pres ID comprises generating said ENC PID and generating said Pres ID.

6. The method of claim 1 wherein said receiving in said PM CS said order for said prescription comprising receiving an electronic message from said electronic address.

7. The method of claim 7 wherein said electronic address is an email address for said patient.

8. The method of claim 1 further comprising receiving, in said PM CS, an authorization from said patient to send said patient electronic communications containing marketing information.

9. The method of claim 1 further comprising receiving, in said PM CS, an authorization from said patient to send said patient electronic communications containing purchase incentive offers.

10. The method of claim 1 further comprising receiving in said PM CS an order for a refill of said prescription comprising receiving an electronic message from said electronic address.

11. The method of claim 1 further comprising:
receiving in said PM CS an order for a refill of said prescription comprising receiving an electronic message from said electronic address; and
receiving in said PM CS an identification of a hyperlink sent to said electronic address indicating that said hyperlink was activated by a client CS having said electronic address.

12. The method of claim 1 wherein said criteria requires the existence of a second prescription record associated with at least one of said ENC PID and said Pres ID and a specified medicine.

13. The method of claim 12 wherein said criteria requires said second prescription record to:
define a time of ordering, of the prescription defined by said second prescription record, to be within a prior time period; and
to contain said ENC PID.

14. The method of claim 1 wherein said generating, in said PM CS, said prescription record for said prescription comprises storing in memory in association with one another, at least patient name, drug identifier, drug quantity, and drug usage.

15. The method of claim 1 further comprising de-identifying, in said PM CS, said prescription record resulting in a de-identified prescription record.

16. The method of claim 1 wherein said de-identifying comprises selecting fields from a prescription record that do not identify a patient and do not identify how to contact a patient for whom the prescription is written.

17. The method of claim 16 wherein said de-identifying comprises limiting selection of field from a prescription record to avoid selecting at least name, address, telephone number, and email address.

18. The method of claim 1 wherein said transmitting from said PM CS to a HR CS a de identified prescription record comprises transmitting from inside a first network including said PM CS to inside a different second network including said HR CS.

19. The method of claim 18 wherein said transmitting from said first network to said second network is via a virtual private network connection over a public network.

20. The method of claim 1 further comprising said transmitting, from one of said PM CS and an Email CS to said electronic address for said patient at least one of marketing information and an incentive offer contained in said Payload.

21. The method of claim 1 further comprising transmitting from a client CS having said electronic address a communication indicating receipt of said additional drug information.

22. The method of claim 1 further comprising transmitting from a client CS having said electronic address a communication providing an indication of receipt of at least one of marketing information and an incentive offer by said client CS.

23. The method of claim 22 further comprising receiving, in said PM CS, said indication of receipt.

24. The method of claim 23 further comprising depending printing of information in said PM CS for said patient based upon receipt in said PM CS of said indication of receipt.

25. The method of claim 1 wherein said PM CS stores in a data structure in memory associations of PIDs and corresponding ENC PIDs.

26. The method of claim 1 wherein said PM CS stores in memory patient prescription data that identifies the patient in a Patient Record table, and stores data defining prescriptions in a Patient Prescriptions Table.

27. The method of claim 26 wherein said PM CS stores a relational link via a table relating PID to ENC PID, between a PID field in said Patient Record table and an ENC PID field in said Patient Prescriptions Table.

28. The method of claim 1 wherein said Payload includes instructions for said PM CS to implement filling of said prescription.

29. The method of claim 1 wherein said Payload includes elements of data for printing in a prescription label for said prescription.

30. A computer system for limiting printing of information relating to a pharmacy prescription, comprising:
a PM CS configured to receive an electronic address for a patient, an order for a prescription for said patient, and an authorization from said patient to send said patient electronic communications containing additional drug information to said electronic address;
said PM CS configured to generate a prescription record for said prescription including at least one of an encrypted patient identifier, ENC PID, for said patient and a prescription record identifier, Pres ID, for said prescription record;
a HR CS;
said PM CS configured to transmit to said HR CS a de identified prescription record;
said HR CS configured to apply criteria to at least said de identified prescription record;
said HR CS configured to determine as a result of applying said criteria, a Payload;
wherein said Payload contains additional drug information for a drug specified by said prescription;
said HR CS configured to associate said Payload with at least one of said ENC PID and said Pres ID;
said HR CS configured to transmit to said PM CS, said Payload in association with at least one of said ENC PID and said Pres ID;
said PM CS or an Email CS configured to transmit to said electronic address for said patient said additional drug information contained in said Payload;
said PM CS configured to determine an additional drug information transmission determination indicating either whether said additional drug information was transmitted to said electronic address for said patient or whether said additional drug information was received by said electronic address for said patient;
said PM CS configured to display instructions for filling said prescription in a pharmacy associated with said PM CS; and
said PM CS configured to print said additional drug information for the filled prescription, if said additional drug information transmission determination does not indicate that said additional drug information was transmitted to or received at said electronic address for said patient.

31. A method of limiting printing of information relating to a pharmacy prescription, comprising:
receiving, in a PM CS, an electronic address for a patient;
receiving, in said PM CS, an order for a prescription for said patient;
receiving, in said PM CS, an authorization from said patient to send said patient electronic communications containing additional drug information;
generating, in said PM CS, a prescription record for said prescription;
generating, in said PM CS, at least one of an encrypted patient identifier, ENC PID, for said patient and a prescription record identifier, Pres ID, for said prescription record;
including, in said PM CS, in said prescription record, at least one of said ENC PID and said Pres ID;
transmitting from said PM CS to a HR CS a de identified prescription record;
applying, in said HR CS, criteria to at least said de identified prescription record;
said applying resulting in determining, in said HR CS, an additional drug information Payload;
wherein said additional drug information Payload contains additional drug information for a drug specified by said prescription;
associating said additional drug information Payload with at least one of said ENC PID and said Pres ID;
transmitting, from said HR CS to said PM CS, said additional drug information Payload in association with at least one of said ENC PID and said Pres ID;
transmitting, from one of said PM CS and an Email CS to said electronic address for said patient said additional drug information contained in said additional drug information Payload, and a prompt to opt in to receive at least one of marketing information and incentive offers;
receiving in said PM CS, confirmation that said electronic address received said additional drug information, and a prompt response to said prompt;
determining, in said PM CS, if said prompt response is an opt in;
if said prompt response is an opt in, transmitting said prompt response to said HR CS in association with at least one of said ENC PID and said Pres ID;
in response to receiving in said HR CS said prompt response, applying, in said HR CS, criteria relating to at least one of marketing and incentive offers to at least said de identified prescription record;
said applying resulting in determining, in said HR CS, a second Payload containing at least one of marketing information and an incentive offer;
associating said second Payload with at least one of said ENC PID and said Pres ID;
transmitting from said HR CS to said PM CS said second Payload in association with at least one of said ENC PID and said Pres ID; and
providing information contained in said second Payload to said patient.

32. A computer system for limiting printing of information relating to a pharmacy prescription, comprising:
a PM CS configured to receive an electronic address for a patient, an order for a prescription for said patient, and an authorization from said patient to send said patient electronic communications to said electronic address containing additional drug information;
said PM CS configured to generate a prescription record for said prescription;
said PM CS configured to generate at least one of an encrypted patient identifier, ENC PID, for said patient and a prescription record identifier, Pres ID, for said prescription record;
said PM CS configured to include in said prescription record, at least one of said ENC PID and said Pres ID;
an HR CS;
said PM CS configured to transmit to said HR CS a de identified prescription record;
said HR CS configured to apply criteria to at least said de identified prescription record, to result in an additional drug information Payload;
wherein said additional drug information Payload contains additional drug information for a drug specified by said prescription;
said HR CS configured to associate said additional drug information Payload with at least one of said ENC PID and said Pres ID;
said HR CS configured to transmit to said PM CS said additional drug information Payload in association with at least one of said ENC PID and said Pres ID;
said PM CS configured to transmit or have an Email CS transmit to said electronic address for said patient said additional drug information contained in said additional drug information Payload, and a prompt to opt in to receive at least one of marketing information and incentive offers;
said PM CS configured to receive (1) confirmation that said electronic address received said additional drug information and (2) a prompt response to said prompt;
said PM CS configured to determine if said prompt response is an opt in;
said PM CS configured to, if said prompt response is an opt in, transmit said prompt response to said HR CS in association with at least one of said ENC PID and said Pres ID;
said HR CS configured to, in response to receiving in said HR CS said prompt response, apply criteria relating to at least one of marketing and incentive offers to at least said de identified prescription record, resulting in determining, in said HR CS, a second Payload containing at least one of marketing information and an incentive offer, and to associate said second Payload with at least one of said ENC PID and said Pres ID;
said HR CS configured to transmit to said PM CS said second Payload in association with at least one of said ENC PID and said Pres ID; and
providing information contained in said second Payload to said patient.

33. A method of targeting communications from a PM CS to a patient during filling of an order for a pharmacy prescription, comprising:
receiving, in a PM CS, an electronic address for a patient;
receiving, in said PM CS, an order for a prescription for said patient;
receiving, in said PM CS, an authorization from said patient to send said patient electronic communications containing additional drug information to said electronic address;
generating, in said PM CS, a prescription record for said prescription;
generating, in said PM CS, at least one of an encrypted patient identifier, ENC PID, for said patient and a prescription record identifier, Pres ID, for said prescription record;
including, in said PM CS, in said prescription record, at least one of said ENC PID and said Pres ID;
transmitting from said PM CS to a HR CS a de identified prescription record;
applying, in said HR CS, criteria to at least said de identified prescription record;
said applying resulting in determining, in said HR CS, a Payload;
wherein said Payload contains additional drug information for a drug specified by said prescription;
wherein said Payload contains marketing information including a hyperlink and text identifying a product that is associated with said hyperlink;
associating said Payload with at least one of said ENC PID and said Pres ID;
transmitting, from said HR CS to said PM CS, said Payload in association with at least one of said ENC PID and said Pres ID;
transmitting, from one of said PM CS and an Email CS to said electronic address for said patient, a first communication including:
(a) said additional drug information contained in said Payload;
(b) said marketing information including said hyperlink and said text identifying said product that is associated with said hyperlink contained in said Payload;
(c) client side code instructing a client CS to transmit to a second electronic address:
(1) an indication that said first communication was opened in association with an identity of said first communication; and
(2) an indication that said hyperlink was activated in association with an identity of said hyperlink;
determining in said PM CS that said order for said pharmacy prescription is ready for pickup by said patient;
in response to determining in said PM CS that said order for said pharmacy prescription is ready for pickup by said patient, transmitting, from one of said PM CS and an Email CS, to said electronic address for said patient, a second communication; and
wherein content of said second communication depends upon data received at said second electronic address in response to said client side code in said first communication.

34. The method of claim 33 wherein said second electronic address is an address for said PM CS.

35. The method of claim 33 wherein said second electronic address is an address for said HR CS.

36. The method of claim 35 wherein said client side code also transmits to said HR CS:
(3) at least one of ENC PID and a de identified or encrypted version of Pres ID.

37. The method of claim 33 wherein said product is a drug.
